(19) United States
(12) Patent Application Publication
(10) Pub. No.: US 2018/0228120 A1
(43) Pub. Date: Aug. 16, 2018

(54) PET CARRIER WITH INTEGRAL BOX

(71) Applicant: HUI-CHU LAICHENG, Taichung (TW)

(72) Inventor: HUI-CHU LAICHENG, Taichung (TW)

(73) Assignee: HUI-CHU LAICHENG

(21) Appl. No.: 15/434,974

(22) Filed: Feb. 16, 2017

(51) Int. Cl. A01K 1/00; A01K 1/02; A45C 5/14; A45C 13/30

(52) U.S. Cl. CPC A01K 1/0035; A01K 1/0058; A01K 1/0064; A45C 2013/306; A45C 5/14; A45C 13/30; A01K 1/029

(57) ABSTRACT

A pet carrier includes a main box and a door. The main box has a lateral wall and a back board to form an integral member. The main box has an opening and a room therein. The main box is provided with a plurality of ventilation bores, which are communicated with the room. The main box is provided with two ribs to enhance its strength. The door connected to the main box to open and close the opening.

### BACKGROUND OF THE INVENTION

### 1. Technical Field

The present invention relates to an appliance for pets, and more particularly to a pet carrier with an integral box.

### 2. Description of Related Art

Pet carriers usually have a box or a bag to receive a pet for user to carry it. The way of “carry” includes holding, carrying on the back, and dragging. The pet stays in the box (or bag) with bores for the pet to breath.

U.S. Pat. No. 5,154,137 disclosed a whelping box, including a top half box, a low half box, and a door. The top half box is connected to the low half box with a plurality of locking devices, so the top half box and the low half box could be connected and separated. A handle is provided on the whelping box for a user to hold it.

China patent no. 201620775113.3 disclosed a pet trolley, having a top half box, a low half box, and a zip to connect the top half box to the low half box. A handle is connected to a back of the box, and a plurality of wheels connected to a bottom of the box for a user to hold the handle and drag the pet trolley.

Both of the patents provide the box with two half boxes. The half boxes might be separated by the pet therein hitting the box or by an external impact.

### BRIEF SUMMARY OF THE INVENTION

In view of the above, the primary objective of the present invention is to provide a pet carrier, which has a simple structure and a great strength.

The secondary objective of the present invention is to provide a pet carrier, which provides an easy way for storage, and has a good storing space.

In order to achieve the objective of the present invention, a pet carrier includes a main box having a lateral wall and a back board to form an integral member, wherein the main box has an opening and a room therein, and the opening is communicated with the room; the main box is provided with a plurality of ventilation bores, which are communicated with the room; and a door connected to the main box to open and close the opening.

In an embodiment, the main box is provided with at least a rib, or at least a concave portion to enhance a strength thereof.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of a preferred embodiment of the present invention;

FIG. 2 is another perspective view of the preferred embodiment of the present invention;

FIG. 3 is a perspective view of the preferred embodiment of the present invention, showing the door being opened;

FIG. 4 is a perspective view of the preferred embodiment of the present invention, showing the handle being extended;

FIG. 5 is a perspective view of the preferred embodiment of the present invention, showing the secondary box on the main box; and

FIG. 6 is a perspective view of the preferred embodiment of the present invention, showing the secondary box in the main box.

### DETAILED DESCRIPTION OF THE INVENTION

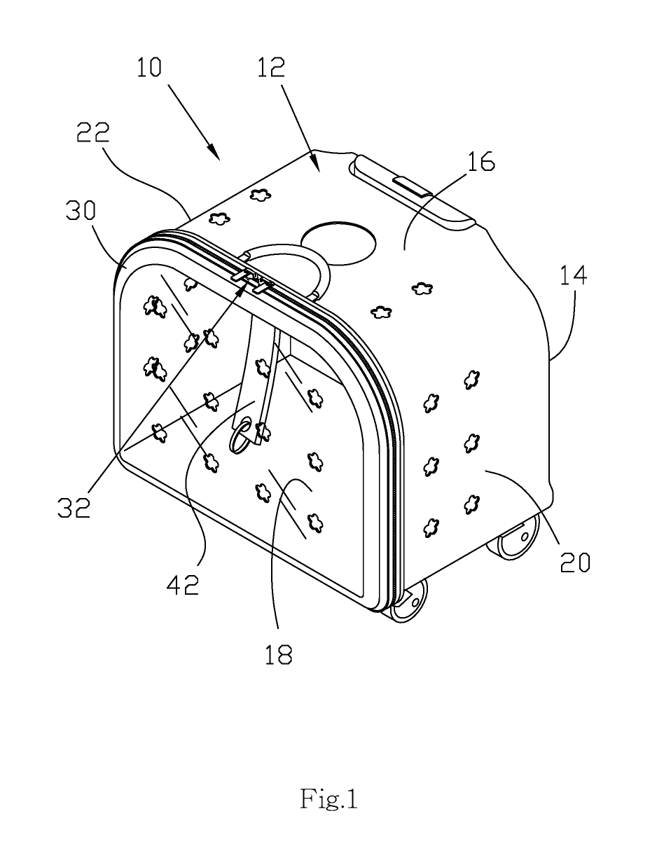

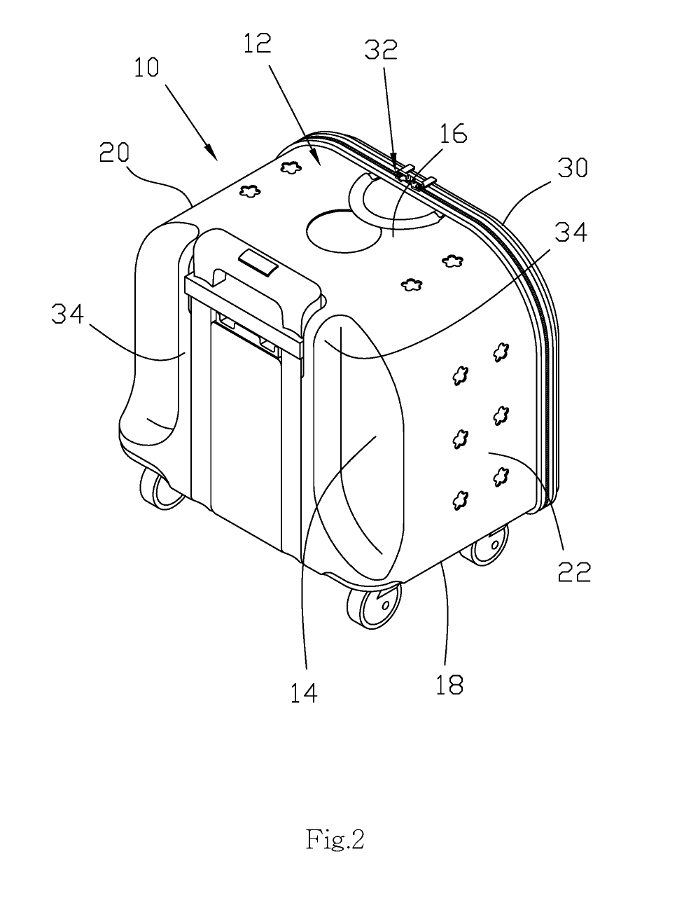

As shown in FIGS. 1 and 2, a pet carrier of the preferred embodiment of the present invention includes a main box 10 and a door 30. The main box 10 is an integral member, including a lateral wall 12 and a back board 14. The lateral wall 12 has a top portion 16, a bottom portion 18, and two side portions 22 and 24 to form a continuous rectangular frame. The main box 10 is made by blow molding or injection molding. The door 30 is a transparent board connected to the lateral wall 12 of the main box 10 through a zip 32, so that the door 30 may be closed by zipping the zip 32, and opened by unzipping the zip 32.

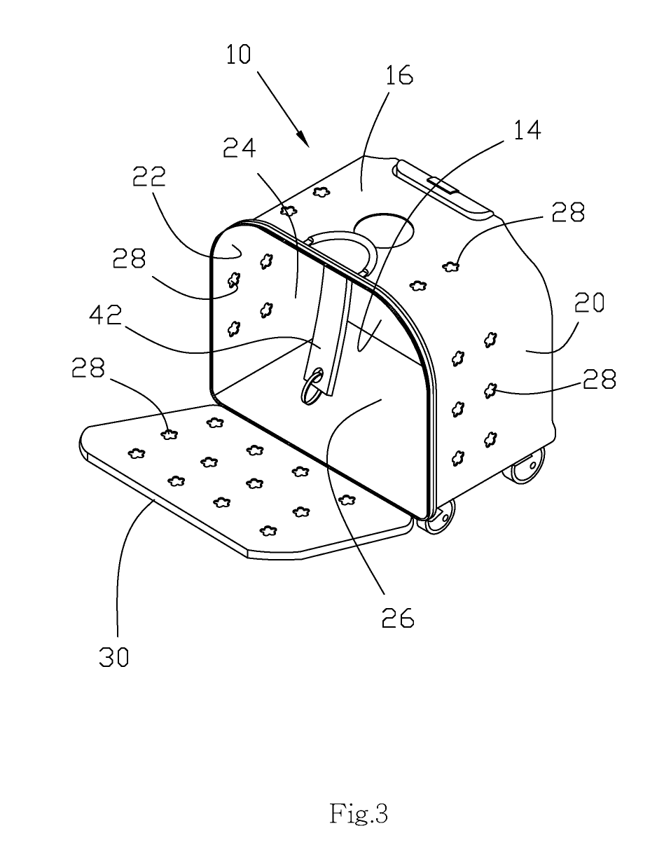

As shown in FIG. 3, the main box 10 has an opening 24 at a side opposite to the back board 14 and a room 26 therein. The opening 24 becomes an entrance of the room 26. The main box 10 further is provided with a plurality of ventilation bores 28 at the top portion 16 and the side portions 20, 22. The ventilation bores 28 are communicated with the room 26. The door 30 closes or opens the opening 24, and has a plurality of ventilation bores 28 as well.

As shown in FIG. 2, the main box 10 has two concave portions at junctions of the back board 14 and top portion 16 and the side portions 22, 24 the lateral wall 12, so that a convex portion is formed on the back board 14 between the concave portions. The convex portion further has a recess at a top thereof to mount a handle 36. As a result, two ribs 34 are formed at the convex portion between the handle 36 and the concave portions.

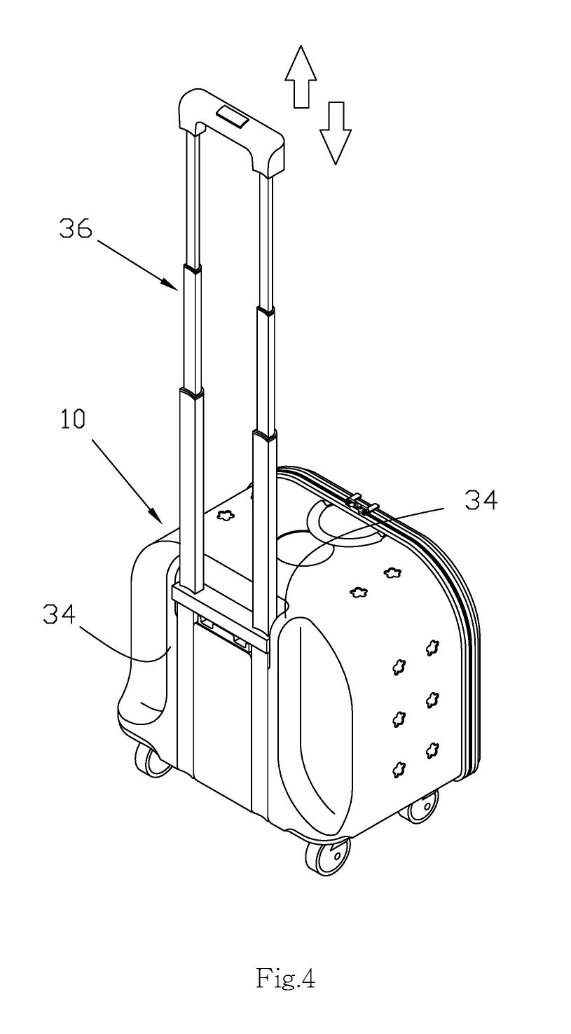

As shown in FIG. 4, the handle 36 is retractable to be extended for a user to hold it, and retracted to store it. The main box 10 is provided with a plurality of wheels, therefore, a user may hold the handle 36 to drag the pet carrier to walk.

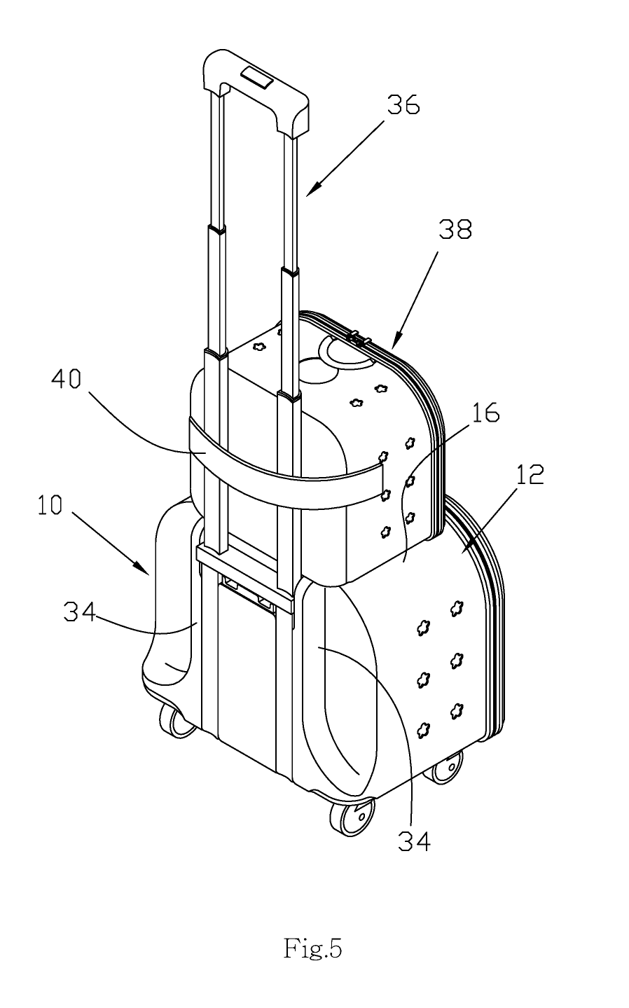

As shown in FIG. 5, a secondary box 38 may be put on the top portion 16 of the main box 10 with a belt 40 looping around the extended handle 36. In this condition, the secondary box 38 rests on the ribs 34 of the main box 10.

As shown in FIGS. 1 to 4, a pet (not shown) may be put into the room 26 of the main box 10, and the door 30 may be closed by zipping the zip 32. The ventilation bores 28 of the main box 10 and the door 30 let the pet therein may breathe. The main box 10 is an integral member with the concave portions and the ribs 34, which provides a great strength to prevent the main box 10 from being deformed or broken by an external impact or the impact by the pet therein. Furthermore, the transparent door 30 lets the pet therein see outside, which may calm the pet.

In another embodiment, the opening is provided at a top of the main box (not shown). Yet in another embodiment, the door is a cap-like member or a hat-like member (not shown), or is a web (not shown).

As shown in FIG. 5, the secondary box 38 provides another room to receive pets, therefore, user may carry two or more pet by securing the secondary box 38 on the main box 10 as described above. The ribs 34 or the concave portions provide the main box 10 a sufficient strength to sustain the secondary box 38, even a pet in the second box 38, to keep the room 26 in the main box 10 and make the pet therein safe.

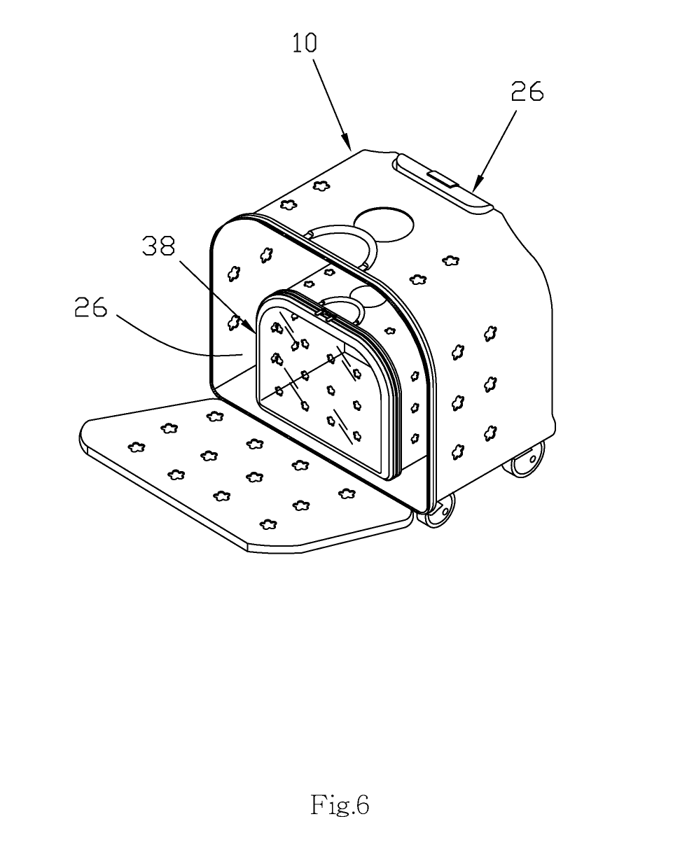

As shown in FIG. 6, a size of the secondary box 38 is smaller than the room 26 of the main box 10 to be received in the room 26, and the handle 36 is retracted to reduce a size of the pet carrier for storage.

As shown in FIGS. 1 and 3, the pet carrier further includes a strip 42 received in the room 26 of the main box 10, and having an end connected to an inner side of the top portion 16 of the main box 10. The strip 42 is flexible and able to connect to a collar of the pet to make sure the pet will stay in the main box 10.

It must be pointed out that the embodiments described above are only some preferred embodiments of the present invention. All equivalent structures which employ the concepts disclosed in this specification and the appended claims should fall within the scope of the present invention.

What is claimed is:

1. A pet carrier, comprising:
a main box having a lateral wall and a back board to form an integral member, wherein the main box has an opening and a room therein, and the opening is communicated with the room; the main box is provided with a plurality of ventilation bores, which are communicated with the room; and
a door connected to the main box to open and close the opening.

2. The pet carrier of claim 1, wherein the main box is provided with two ribs on the back board.

3. The pet carrier of claim 1, wherein the main box has a concave portion.

4. The pet carrier of claim 3, wherein the concave portion is formed on a junction of the back board and the lateral wall.

5. The pet carrier of claim 4, wherein the lateral wall has a top portion, a bottom portion opposite to the top portion, and two lateral portions connected to the top portion and the bottom portion, and the concave portion is formed on a junction of the back board and the top portion and a junction of the back board and the lateral portion.

6. The pet carrier of claim 3, wherein the main box has a convex portion beside the concave portion.

7. The pet carrier of claim 2, further comprising a handle and a plurality of wheels connected to the main box, wherein the handle is between the ribs.

8. The pet carrier of claim 1, further comprising a secondary box, wherein the secondary box is provided with a belt, and a size of the secondary box is smaller than the room of the main box to be received in the room of the main box.

9. The pet carrier of claim 1, further comprising a strip received in the room of the main box and having an end connected to an inner side of the main box.

10. The pet carrier of claim 1, wherein the door is transparent and connected to the main box through a zip.
